(19) United States
(12) Patent Application Publication
(10) Pub. No.: US 2024/0366477 A1
(43) Pub. Date: Nov. 7, 2024

(54) Flavored Teething Device for Infants

(71) Applicant: Kristina Chapman, Ottawa (CA)

(72) Inventor: Kristina Chapman, Ottawa (CA)

(21) Appl. No.: 18/461,572

(22) Filed: Sep. 6, 2023

Related U.S. Application Data
(60) Provisional application No. 63/500,025, filed on May 4, 2023.

(51) Int. Cl. A61J 17/02; A61J 17/00

(52) U.S. Cl. CPC A61J 17/02; A61J 17/101; A61J 17/109

(57) ABSTRACT

An infant teething device having a one-piece construction. In one embodiment, the teething device resembles a wine bottle opener, featuring a handle and a transverse screw member extending from the middle of the handle. A cork stopper is integrally attached to the bottom end of the screw member. The teething device can be easily gripped by an infant using the handle, screw, or cork stopper. Furthermore, the device is infused or coated with a flavoring substance to provide a pleasant taste experience during teething. The teething device can be made from silicone, natural rubber, or thermoplastic elastomers, and is non-toxic, BPA-free, and compliant with safety regulations. In other embodiments, the cork stopper is hollow with an opening on its bottom surface, allowing the cork stopper to be filled with a chilled and flavored substance.

### CROSS-REFERENCE TO RELATED APPLICATION

The present application claims priority to, and the benefit of, U.S. Provisional Application No. 63/500,025, which was filed on May 4, 2023 and is incorporated herein by reference in its entirety.

### FIELD OF THE INVENTION

The present invention generally relates to the field of teething devices. More specifically, the present invention relates to a novel flavored teething device which does not have any removable parts. The teething device is in the shape of a wine bottle opener and includes a wine bottle opener handle and a cork stopper. The device is infused with a flavoring substance and can be held easily by an infant. The device is a safe and unique toy for children to chew on while teething to maintain comfort and happiness. Accordingly, the present disclosure makes specific reference thereto. Nonetheless, it is to be appreciated that aspects of the present invention are also equally applicable to other like applications, devices, and methods of manufacture.

### BACKGROUND

By way of background, teething is eruption of an infant's primary teeth, also known as baby teeth or milk teeth, through the gums. The teething process is a natural phenomenon and commonly begins around 6 months of age and can continue until the child is about 3 years old. Teething can be challenging and uncomfortable for both infants and their parents. During teething, the new teeth push through the gums, causing the gums to become swollen and tender. This results in pain and discomfort for the infant. The babies are not able to communicate their discomfort effectively, and as a result they become irritable, fussy, and can experience difficulty sleeping or eating. Some infants may also drool more than usual during this time.

For alleviating the discomfort associated with the teething, parents often give soft toys or other types of toys for distracting infants. Such toys keep the infants busy and occupied during the teething process. Many parents give chilled washcloths to children as cold temperatures help numb the gums, reducing inflammation and providing temporary and instant relief. Parents also provide engaging activities, such as age-appropriate toys or interactive play, which can help divert the child's attention away from the discomfort they are experiencing. However, such conventional devices and methods are ineffective and require considerable effort from parents to soothe the infants. Many conventional toys, teething devices, and more have removable pieces and can be swallowed by infants which can choke them. Individuals desire improved devices that are safe, effective, and useful to help alleviate discomfort during teething process of infants.

Therefore, there exists a long felt need in the art for a specifically designed teething device for infants. There is also a long felt need in the art for an infant teething device that does not contain any removable pieces. Additionally, there is a long felt need in the art for an infant teething device that provides flavor to infants. Moreover, there is a long felt need in the art for an improved teething device that is not swallowed by infants. Further, there is a long felt need in the art of a teething device that helps alleviate teething pain and soothes gums of infants. Furthermore, there is a long felt need in the art for a teething device that simulates gums of infants and provides relief from teething pain. Finally, there is a long felt need in the art for a teething device that keeps infants engaged, entertained and is safe for chewing to maintain their comfort and happiness.

The subject matter disclosed and claimed herein, in one embodiment thereof, comprises an infant flavored teething device. The teething device is in the shape of a wine bottle opener handle and cork stopper and has a one-piece construction made of silicone or natural rubber. The device includes a wine bottle opener handle, a screw member that extends transversely downwards from a middle of the handle, and a cork stopper integrally attached to a bottom end of the screw member. The cork stopper is also transverse to the handle and is collinear to the screw member. A plurality of rubber nubs is positioned along the length of the handle for soothing swollen gums of an infant during teething, wherein the rubber nubs contact all the swollen gums simultaneously when the handle is bitten down by the infant. The teething device is also infused with a flavoring substance to provide a flavor to the infant during use by the infant.

In this manner, the infant flavored teething device of the present invention accomplishes all of the forgoing objectives and provides users with an infant teething device that looks like a wine bottle opener handle and cork. The device features multiple rubber nubs for children to play with as they teethe and utilizes a safe silicone material for construction without any removable parts, thereby eliminating chocking. The device also provides a pleasant flavorful scent to enhance teething experiences.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an infant teething device. The teething device is in the shape of a wine bottle opener handle and cork stopper and further comprising a one-piece construction made of silicone, a wine bottle opener handle, a screw member extending transversely downwards from middle of the handle, a cork stopper integrally attached to a bottom end of the screw member, a plurality of rubber nubs positioned along the length of the handle for soothing swollen gums of an infant during teething, wherein the rubber nubs contact all the swollen gums simultaneously when the handle is bitten down by the infant, a plurality of rubber nubs on the cork stopper for soothing swollen gums of an infant, and the teething device is infused with a flavoring substance to provide a flavor to the infant during use by the infant.

In yet another embodiment, a logo or indicia is disposed on the cork stopper for branding and marketing purposes and the teething device is non-toxic, BPA-free, and compliant with safety regulations.

In yet another embodiment, the handle has a length in the range of 2″ to 5″ and abuts against the face of an infant during use.

In yet another embodiment, the rubber nubs on the handle can contact all the swollen gums and provide sensory experience by stimulating their senses.

In yet another embodiment, the teething device can be made from natural rubber or silicone, providing a soft and flexible texture for enhanced chewing and gum massage during the teething process.

In a further embodiment, a flavored teething device is disclosed. The teething device includes a wine bottle opener handle, a cork stopper, the cork stopper and the handle are transverse and connected using a screw member, the cork stopper configured as hollow with a bottom surface having an opening, a cover for sealing the opening, which remains secured unless manually removed by a user, a chilled and flavored substance filled within the hollow cork stopper, a plurality of openings on the handle to provide accessibility to the flavored substance wherein the flavored substance flows from the cork stopper to the handle.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of an infant teething device of the present invention in accordance with the disclosed architecture;

FIG. 2 illustrates a perspective view of an infant biting the handle for soothing gums in accordance with the disclosed architecture;

FIG. 3 illustrates a perspective view of the infant using the teething device in another configuration in accordance with the disclosed architecture;

FIG. 4 illustrates a bottom/right perspective view of another embodiment of the cork stopper of the flavored teething device of the present invention in accordance with the disclosed architecture; and

FIG. 5 illustrates another perspective view of the cork stopper used in the flavored teething device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a specifically designed teething device for infants. There is also a long felt need in the art for an infant teething device that does not contain any removable pieces. Additionally, there is a long felt need in the art for an infant teething device that provides flavor to infants. Moreover, there is a long felt need in the art for an improved teething device that is not swallowed by infants. Further, there is a long felt need in the art of a teething device that helps alleviate teething pain and soothes gums of infants. Furthermore, there is a long felt need in the art for a teething device that simulates gums of infants and provides relief from teething pain. Finally, there is a long felt need in the art for a teething device that keeps infants engaged, entertained, and is safe for chewing to maintain their comfort and happiness.

The present invention, in one exemplary embodiment, is a flavored teething device. The teething device is in the shape of a wine bottle opener and includes a wine bottle opener handle and a cork stopper, wherein both are interconnected using a screw member therebetween. The cork stopper and the handle are transverse and the cork stopper is configured as hollow with a bottom surface having an opening. A sturdy cover is used for sealing the opening, which remains secured unless manually removed by a user. A chilled and flavored substance is filled inside the hollow cork stopper and the flavored substance flows from the cork stopper to the handle. A plurality of openings on the handle provides accessibility to the flavored substance wherein the flavored substance flows from the cork stopper to the handle.

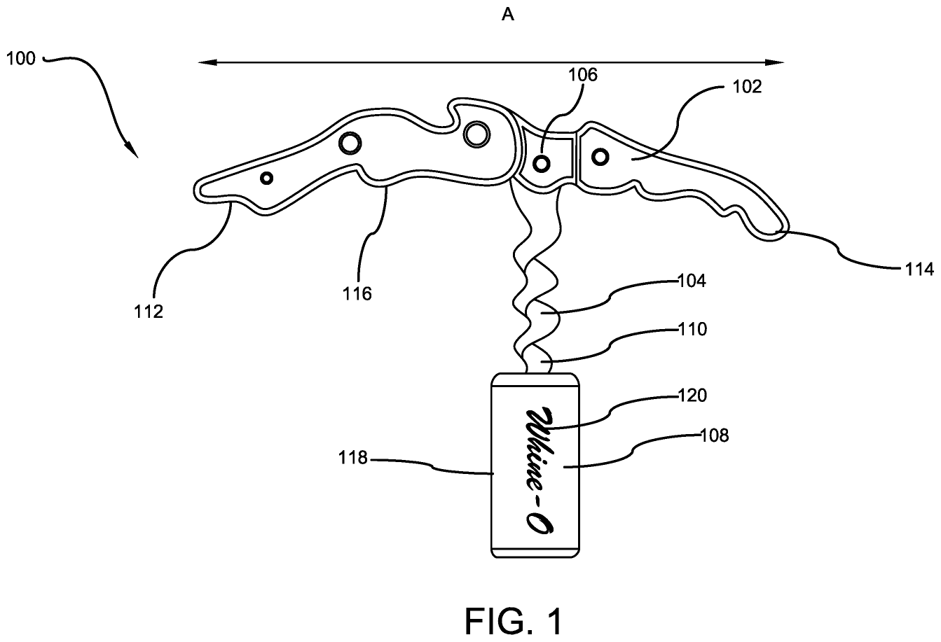

Referring initially to the drawings, FIG. 1 illustrates a perspective view of an infant teething device of the present invention in accordance with the disclosed architecture. The infant teething device 100 of the present invention is configured for massaging the gums, soothing teeth, and providing or imparting a flavor to an infant. The teething device 100 is made of silicone and has a one-piece construction without any removable teething parts. More specifically, the teething device 100, in the present embodiment is in the shape of a wine bottle opener and includes a handle 102 and a screw member 104 extending transversely from a middle 106 of the handle 102. A cork stopper 108 is integrally attached to the bottom end 110 of the screw member 104.

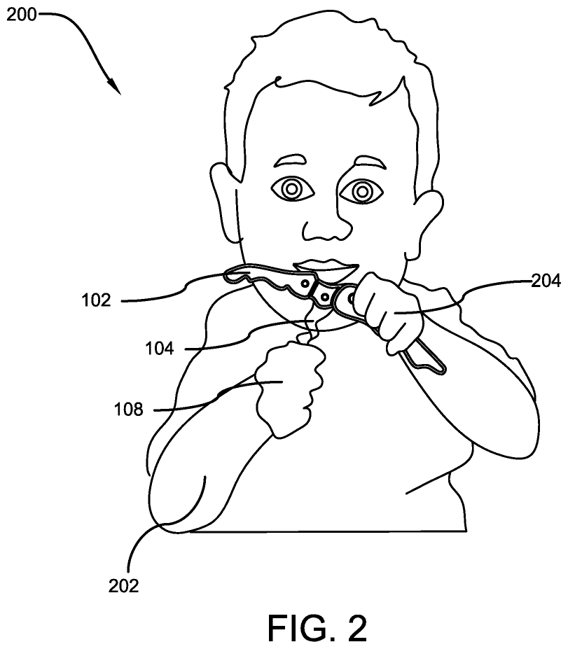

The teething device handle 102 has a length (shown by arrow “A”) extending between the two end points 112, 114 and is in the range from 2″ to 5″ such that the handle 102 abuts against the face of an infant when the infant uses the teething device 100 as illustrated in FIG. 2, thereby preventing swallowing of the handle 102 by the infant. The handle 102 includes a plurality of rubber nubs 116 to soothe swollen gums of the infant during the teething process. The rubber nubs 116 are positioned along the length of the handle 102 and can contact all the swollen gums simultaneously of an infant when the handle 102 is bitten down, gummed, or chewed by the infant. The cork stopper 108 is also transverse to the handle 102 and has a diameter in the range from 0.3″ to 1″, thereby allowing an infant to easily chew the cork stopper 108. The cork stopper 108 also has a plurality of rubber nubs 118 for soothing swollen gums of the infant.

The device 100 can be easily gripped by an infant using any of the handle 102, screw 104, and cork stopper 108. Further, the device 100 is coated with a flavoring substance for providing or imparting a flavor to an infant during use of the teething device 100. The flavor can be any conventional flavor to meet taste requirements of different infants. A logo or indicia 120 is disposed on the cork stopper 108 for branding and marketing purposes. The teething device 100 can be made from one of silicone, natural rubber, and thermoplastic elastomers. Further, the teething device 100 is non-toxic, BPA-free, and comply with safety regulations.

FIG. 2 illustrates a perspective view of an infant biting the handle for soothing gums in accordance with the disclosed architecture. The device 100 can be easily held by an infant 200 using both hands 202, 204 while using the teething device 100. As illustrated, the handle 102 when bitten down by the infant 200 abuts against face 206 of the infant 200 while the rubber nubs 116 contact all the gums of the infant 200. The device 100 can be pulled by the infant 200 by pulling the cork stopper 108 and further can be laterally moved along the face 206.

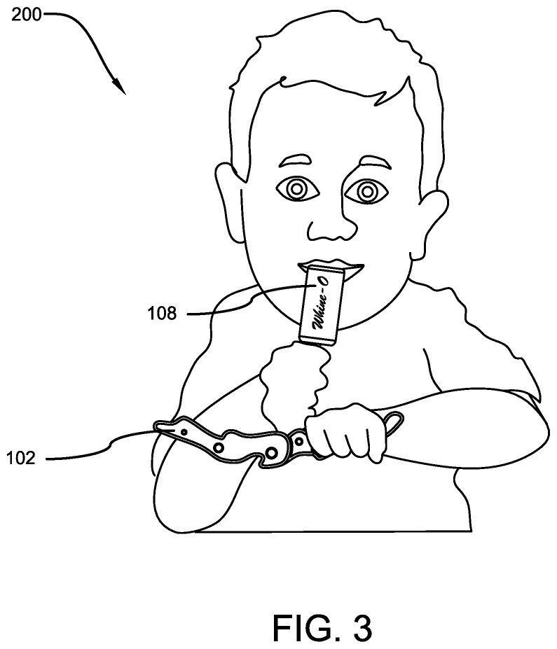

FIG. 3 illustrates a perspective view of the infant using the teething device in another configuration in accordance with the disclosed architecture. In the present embodiment, the infant 200 uses the device 100 in an inverted position, for example, chewing the cork stopper 108 to soothe swollen gums. The diameter of the cork stopper 108 is designed to easily go inside the mouth of the infant 200 and can contact some of the gums of the infant 200.

The teething device 100 can be placed in a freezer to chill the device 100 as cold temperatures are soothing during teething process. Furthermore, the flavored substance included in the device 100 provides a soothing flavor to the infant 200.

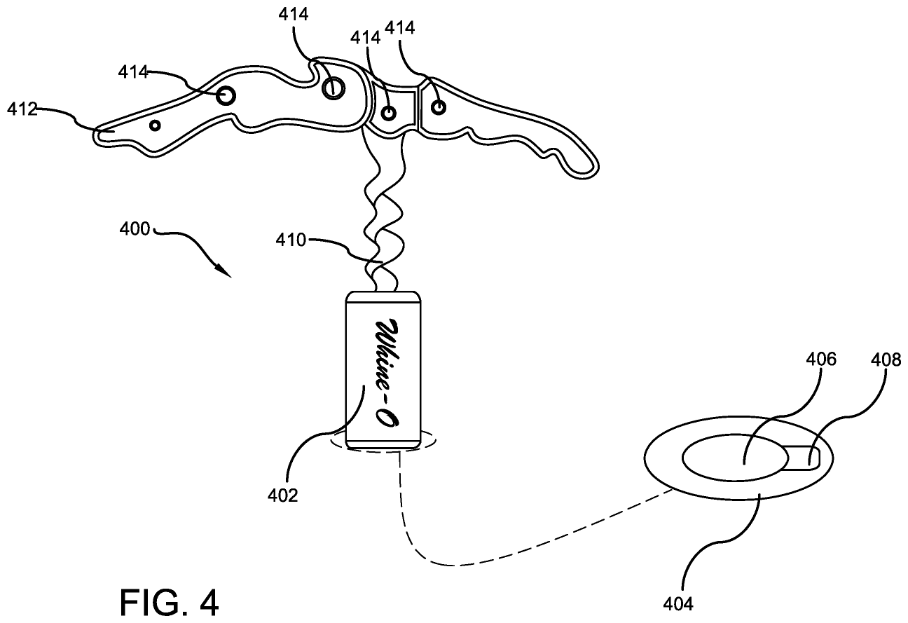

FIG. 4 illustrates a bottom/right perspective view of another embodiment of the cork stopper of the flavored teething device of the present invention in accordance with the disclosed architecture. In the present embodiment, the cork stopper 402 of the teething device 400 is hollow and the bottom surface 404 of cork stopper 402 has an opening 406 for filling the cork stopper 402 with a chilled and flavored substance. The opening 406 can be sealed with a hinged cover 408 which remains secured unless removed manually by a user such as a parent or caretaker. The flavored substance filled in the cork stopper 402 can flow through the hollow screw member 410 and the hollow handle 412 with the flavored substance being accessible through the openings 414 on the handle 412 as well.

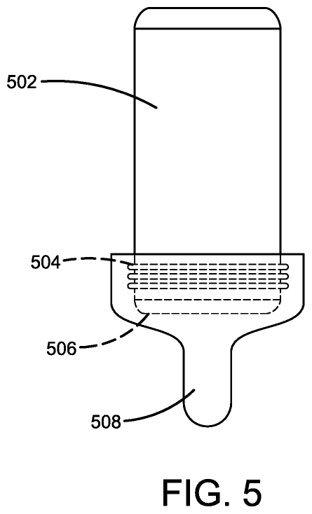

FIG. 5 illustrates another perspective view of the cork stopper used in the flavored teething device of the present invention in accordance with the disclosed architecture. As illustrated, the cork stopper 502 has securing grooves 504 around the bottom surface 506 thereof for detachably attaching a nipple 508 for using the teething device as a pacifier. The securing grooves 504 are designed to secure the nipple 508 to prevent the nipple 508 from getting detached when the nipple 508 is sucked by an infant.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “infant teething device”, “teething device”, “flavored teething device”, and “device” are interchangeable and refer to the infant flavored teething device 100,400 of the present invention.

Notwithstanding the forgoing, the infant flavored teething device 100,400 of the present invention can be of any suitable size and configuration as is known in the art without affecting the overall concept of the invention, provided that it accomplishes the above stated objectives. One of ordinary skill in the art will appreciate that the infant flavored teething device 100,400 as shown in the FIGS. are for illustrative purposes only, and that many other sizes and shapes of the infant flavored teething device 100,400 are well within the scope of the present disclosure. Although the dimensions of the infant flavored teething device 100,400 are important design parameters for user convenience, the infant flavored teething device 100,400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A teething device for massaging gums comprising:
a teething device having a one-piece construction including a handle member, a screw member, and a cork stopper member;
wherein said screw member extending transversely from a middle of said handle member to said cork stopper member;
wherein said cork stopper member integrally attached to a bottom end of said screw member;
wherein said handle member having a length from 2 inches to 5 inches;
wherein said handle member having a plurality of nubs extending from an outer surface of said handle member; and
further wherein said plurality of nubs positioned along a length of said handle member.

2. The teething device for massaging gums of claim 1, wherein said cork stopper member transverse to said handle member.

3. The teething device for massaging gums of claim 2, wherein said cork stopper member having a diameter from 0.3″ to 1″.

4. The teething device for massaging gums of claim 3, wherein said cork stopper member having a plurality of nubs.

5. The teething device for massaging gums of claim 4, wherein said teething device having a flavoring substance for imparting a flavor to said teething device.

6. The teething device for massaging gums of claim 5, wherein said teething device having a material selected from a group consisting of a silicone, a natural rubber, and a thermoplastic elastomer.

7. The teething device for massaging gums of claim 6, wherein said teething device is freezable.

8. A teething device for massaging gums comprising:
a teething device having a one-piece construction including a handle member, a screw member, and a cork stopper member;
wherein said screw member extending transversely from a middle of said handle member to said cork stopper member;
wherein said cork stopper member integrally attached to a bottom end of said screw member;
wherein said handle member having a length from 2 inches to 5 inches;
wherein said handle member having a plurality of nubs extending from an outer surface of said handle member;
wherein said plurality of nubs positioned along a length of said handle member;
wherein said cork stopper member is hollow including a bottom surface having a hinged cover; and
further wherein said cork stopper member having a chilled and flavored substance contained in said cork stopper member.

9. The teething device for massaging gums of claim 8, wherein said cork stopper member transverse to said handle member.

10. The teething device for massaging gums of claim 9, wherein said cork stopper member having a diameter from 0.3″ to 1″.

11. The teething device for massaging gums of claim 10, wherein said cork stopper member having a plurality of nubs.

12. The teething device for massaging gums of claim 11, wherein said teething device having said flavored substance for imparting a flavor to said teething device.

13. The teething device for massaging gums of claim 12, wherein said teething device having a material selected from a group consisting of a silicone, a natural rubber, and a thermoplastic elastomer.

14. The teething device for massaging gums of claim 13, wherein said teething device is freezable.

15. A teething device for massaging gums comprising:
a teething device having a one-piece construction including a hollow handle member, a hollow screw member, and a hollow cork stopper member;
wherein said hollow screw member extending transversely from a middle of said hollow handle member to said hollow cork stopper member;
wherein said hollow cork stopper member integrally attached to a bottom end of said hollow screw member;
wherein said hollow handle member having a plurality of openings;
wherein said hollow handle member having a plurality of nubs extending from an outer surface of said hollow handle member;
wherein said plurality of nubs positioned along a length of said hollow handle member;
wherein said hollow cork stopper member including a bottom surface having a hinged cover;
wherein said hollow cork stopper member having a chilled and flavored substance contained in said hollow cork stopper member;
wherein said flavored substance flows through said hollow screw member and said hollow handle member; and
further wherein said flavored substance accessible through said openings in said hollow handle member.

16. The teething device for massaging gums of claim 15, wherein said hollow cork stopper having securing grooves around said bottom surface for detachably attaching a nipple.

17. The teething device for massaging gums of claim 16, wherein said hollow cork stopper member transverse to said hollow handle member.

18. The teething device for massaging gums of claim 17, wherein said hollow cork stopper member having a diameter from 0.3″ to 1″.

19. The teething device for massaging gums of claim 18, wherein said hollow cork stopper member having a plurality of nubs.

20. The teething device for massaging gums of claim 19, wherein said teething device having a material selected from a group consisting of a silicone, a natural rubber, and a thermoplastic elastomer.
